(19) United States
(12) Patent Application Publication
(10) Pub. No.: US 2021/0271221 A1
(43) Pub. Date: Sep. 2, 2021

(54) GIMBAL CONTROL METHOD, GIMBAL, AND UNMANNED AERIAL VEHICLE

(71) Applicant: SZ DJI TECHNOLOGY CO., LTD., Shenzhen (CN)

(72) Inventors: Yingzhi WANG, Shenzhen (CN); Shuai LIU, Shenzhen (CN); Changxin HE, Shenzhen (CN); Yong YANG, Shenzhen (CN); Hanping CHEN, Shenzhen (CN)

(21) Appl. No.: 17/321,438

(22) Filed: May 15, 2021

Related U.S. Application Data
(63) Continuation of application No. PCT/CN2018/118517, filed on Nov. 30, 2018.

(51) Int. Cl. G05B 19/19; G05D 3/20; F16M 11/18; F16M 11/12

(52) U.S. Cl. CPC G05B 19/19; G05D 3/20; G05D 1/0094; F16M 11/123; F16M 11/18

(57) ABSTRACT

A gimbal control method includes obtaining a target attitude parameter of a target attitude of an active gimbal and transmitting the target attitude parameter to a follower gimbal to adjust the follower gimbal to the target attitude. The target attitude is an attitude that the active gimbal is moving to.

### CROSS-REFERENCE TO RELATED APPLICATION

This application is a continuation of International Application No. PCT/CN2018/118517, filed Nov. 30, 2018, the entire content of which is incorporated herein by reference.

### TECHNICAL FIELD

The present disclosure generally relates to the control technology field and, more particularly, to a gimbal control method, a gimbal, and an unmanned aerial vehicle.

### BACKGROUND

Two gimbals can be mounted at an unmanned aerial vehicle (UAV). In some application scenes, the two gimbals need to be controlled to be maintained to face toward a same direction by a linkage to meet needs of a user under a plurality of scenes. For example, a camera carried by a gimbal at position one is configured to view an external environment as a whole and aim at a photographing target. A camera carried by a gimbal at position two is configured to enlarge the detail of the photographing target. The dual-gimbal linkage control has problems of low control accuracy and stalling at a low speed.

### SUMMARY

Embodiments of the present disclosure provide a gimbal control method. The method includes obtaining a target attitude parameter of a target attitude of an active gimbal and transmitting the target attitude parameter to a follower gimbal to adjust the follower gimbal to the target attitude. The target attitude is an attitude that the active gimbal is moving to.

Embodiments of the present disclosure provide a gimbal used as an active gimbal of an unmanned aerial vehicle. The gimbal includes an input device, an output device, a processor, and a memory. The memory stores a program code that, when executed, causes the processor to control the input device to obtain a target attitude parameter of a target attitude of the active gimbal and control the output device to transmit the target attitude parameter to a follower gimbal included in the unmanned aerial vehicle to adjust the follower gimbal to the target attitude. The target attitude is an attitude that the active gimbal is moving to.

Embodiments of the present disclosure provide an unmanned aerial vehicle including a vehicle body, a power system, an active gimbal, and a follower gimbal. The power system is mounted at the vehicle body and configured to provide power for the unmanned aerial vehicle. The active gimbal includes a first input device, an output device, a first processor, and a first memory. The first memory stores a first program code that, when executed, causes the first processor to control the input device to obtain a target attitude parameter of a target attitude of the active gimbal and control the output device to transmit the target attitude parameter to a follower gimbal included in the unmanned aerial vehicle to adjust the follower gimbal to the target attitude. The target attitude is an attitude that the active gimbal is moving to. The follower gimbal includes a second input device, a second processor, and a second memory. The second memory stores a second program code that, when executed, causes the second processor to control the second input device to receive the target attitude parameter of the target attitude of the active gimbal and control the follower gimbal to be adjusted to the target attitude according to the target attitude parameter.

### BRIEF DESCRIPTION OF THE DRAWINGS

FIG. 1 is a schematic structural diagram of an unmanned aerial vehicle (UAV) system according to some embodiments of the present disclosure.

FIG. 2 is a schematic structural diagram of a UAV according to some embodiments of the present disclosure.

FIG. 3 is a schematic flowchart of a method according to some embodiments of the present disclosure.

FIG. 4 is a schematic structural diagram of a gimbal according to some embodiments of the present disclosure.

FIG. 5 is a schematic diagram showing path selection according to some embodiments of the present disclosure.

FIG. 6 is a schematic flowchart of a method according to some embodiments of the present disclosure.

FIG. 7 is a schematic structural diagram of a gimbal according to some embodiments of the present disclosure.

FIG. 8 is a schematic structural diagram of a gimbal according to some embodiments of the present disclosure.

### DETAILED DESCRIPTION OF THE EMBODIMENTS

The technical solutions of the present disclosure are described in connection with the accompanying drawings of embodiments of the present disclosure. Apparently, described embodiments are merely some embodiments not all embodiments. Based on embodiments of the present disclosure, all other embodiments obtained by those of ordinary skill in the art without creative efforts are within the scope of the present disclosure.

FIG. 1 is a schematic structural diagram of an unmanned aerial vehicle (UAV) system according to some embodiments of the present disclosure. The UAV system includes an active gimbal, a follower gimbal, and a communication circuit. The active gimbal is a gimbal at position 1, and the follower gimbal is a gimbal at position 2. In practical applications, the UAV may include an unmanned vehicle and may be simply referred to as an aerial vehicle. More than two gimbals may be carried by the aerial vehicle, for example, one active gimbal and more than one follower gimbal. Processing manners in the scenario having multiple follower gimbals are similar. Thus, embodiments of the present disclosure take one of the follower gimbals as an example, which should not be understood as only including one follower gimbal. The communication circuit shown in FIG. 1 may include a circuit of the active gimbal or include a circuit independent of the active gimbal. A function of the communication circuit may include forwarding data transmitted by the active gimbal to the follower gimbal.

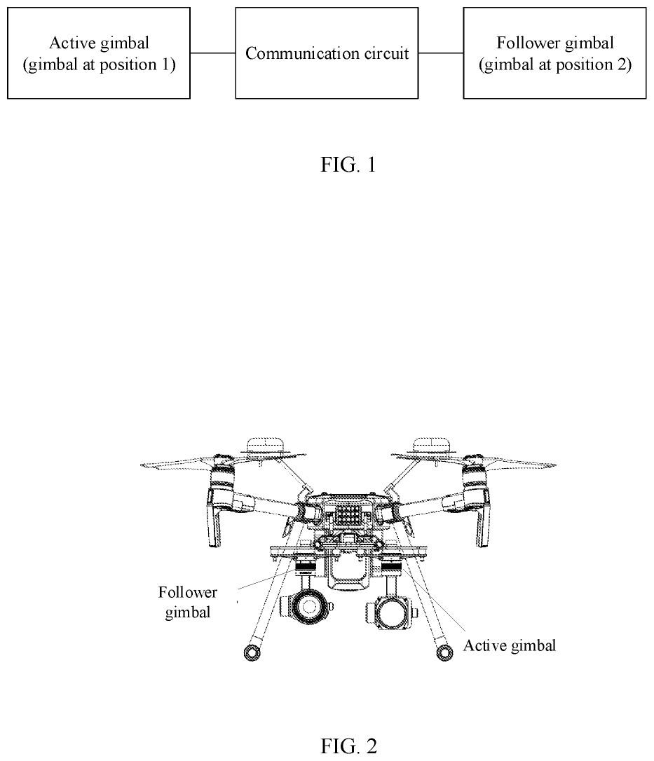

In connection of FIG. 1, FIG. 2 is a schematic structural diagram of the UAV according to some embodiments of the present disclosure. The UAV carries the two gimbals, i.e., the UAV is an aerial vehicle with dual gimbals. The gimbals may carry a camera or a measurement device. The camera may include a visible light camera or an infrared camera. The measurement device may include a laser radar, a millimeter-wave radar, or an ultrasonic radar. As long as there is no conflict, the gimbals may further carry another apparatus.

Under some application scenes, the two gimbals may need to be controlled and maintained to face a same direction through a linkage to meet the needs of the user under a plurality of scenes. For example, the camera carried by the gimbal at position 1 may be configured to view an external environment as a whole and aim at a photographing target. The camera carried by the gimbal at position 2 may be configured to enlarge and view a detail of the photographing target. In embodiments of the present disclosure, the active gimbal and the follower gimbal are included. A gimbal control method provided by embodiments of the present disclosure includes transmitting a target attitude parameter of a target attitude of the active gimbal to the follower gimbal and performing an adjustment on the follower gimbal according to the target attitude of the active gimbal. The follower gimbal may not be adjusted according to a current measurement attitude of the active gimbal as a target, which may cause the follower gimbal to synchronize with the active gimbal more quickly and reduce an attitude difference between the follower gimbal and the active gimbal.

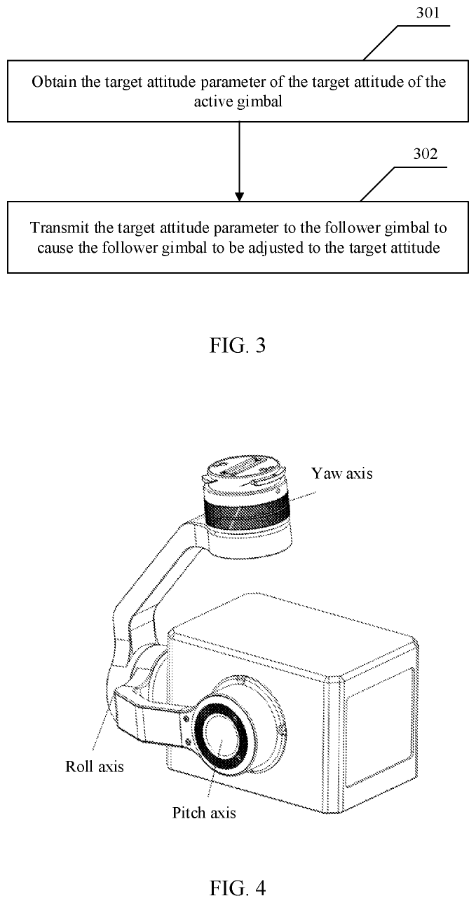

Embodiments of the present disclosure provide the gimbal control method. The gimbal includes the active gimbal and the follower gimbal. The active gimbal and the follower gimbal are in a linkage control mode. The method can be executed by the active gimbal. The communication circuit, functioning as a data forwarding circuit, may be configured to forward the data transmitted by the active to the follower gimbal. As shown in FIG. 3, the method includes the following processes.

At 301, the target attitude parameter of the target attitude of the active gimbal is obtained. The target attitude is an attitude that the active gimbal is going to move to.

The attitude of the gimbal may be represented as a parameter including an Euler angle. The target attitude may include an attitude that the gimbal will move to. The target attitude may be set by an internal program of the UAV or from an external apparatus. For example, a remote-control terminal may enter the target attitude. The remote-control terminal may include a cellphone, a remote controller, or any other apparatus suitable for entering the target attitude of the gimbal.

At 302, the target attitude parameter is transmitted to the follower gimbal to cause the follower gimbal to be adjusted to the target attitude.

The target attitude parameter may include the target attitude parameter or instruction that carries the target attitude parameter and causes the follower gimbal to be adjusted to the target attitude. The present disclosure does not limit this.

In some embodiments, after the target attitude parameter of the target attitude of the active gimbal is obtained, the target attitude parameter may be transmitted to the follower gimbal. Thus, the follower gimbal may be adjusted using the target attitude of the active gimbal instead of using the current measurement attitude of the active gimbal as the target. Therefore, the follower gimbal may synchronize with the active gimbal more quickly, and an attitude difference between the follower gimbal and the active gimbal may be reduced.

The method further includes transmitting current joint angle data of the active gimbal to the follower gimbal to cause joint angle data of the follower gimbal to be adjusted to be same as the current joint angle data of the active gimbal to cause the follower gimbal to avoid a mechanical position limit of the follower gimbal during a process of adjusting the follower gimbal to the target attitude.

In some embodiments, causing joint angle data of the follower gimbal to be adjusted to be same as the current joint angle data of the active gimbal to cause the follower gimbal to avoid a mechanical position limit of the follower gimbal during a process of adjusting the follower gimbal to the target attitude includes, when a difference between the current joint angle data of the active gimbal and the current joint angle data of the follower gimbal is greater than 180°, causing the follower gimbal to be adjusted according to a predetermined movement direction to an attitude corresponding to the current joint angle data of the active gimbal. The predetermined movement direction is opposite to a direction, in which the follower gimbal moves to the attitude corresponding to the current joint angle data of the active gimbal in a shortest path.

In some embodiments, the current joint angle data of the active gimbal may include at least one of a joint angle of a yaw axis motor, a joint angle of a pitch axis motor, or a joint angle of a roll axis motor of the active gimbal.

As shown in FIG. 4, the gimbal includes three rotation axis mechanisms. The three rotation axis mechanisms include the yaw axis motor, the roll axis motor, and the pitch axis motor. In some embodiments, the joint angle parameter may include three portions, such as a yaw axis joint angle, a roll axis joint angle, and a pitch axis joint angle. A joint angle corresponding to the clockwise rotation of the yaw axis motor is a positive value, and the joint angle corresponding to counterclockwise rotation is a negative value. A joint angle corresponding to the clockwise rotation of the roll axis motor is a positive value, and the joint angle corresponding to counterclockwise rotation is a negative value. A joint angle corresponding to the clockwise rotation of the pitch axis motor is a positive value, and the joint angle corresponding to counterclockwise rotation is a negative value. In some embodiments, the rotation mechanism of the gimbal is not limited to three and may include a single-axis rotation mechanism, a dual-axis rotation mechanism, or another form.

According to the current gimbal control strategy, when the gimbal performs attitude adjustment, the gimbal may choose the shortest path to move to the target attitude. Mechanical position limits may be arranged in one or more directions of a yaw direction, a roll direction, and a pitch direction of the gimbal, which causes the gimbal to stop at a position limit attitude. For example, the joint angle of the yaw axis motor of the current gimbal is 178°, and an instruction is −178°, thus, an actual movement path of the gimbal is 178°→179°→180°→−179°→178° instead of 178°→177°→176°→. . . →1°→0°→−1°→−2°→. . . →−177°→−178°. However, some gimbals may include mechanical position limits. For example, if a mechanical position limit is included in the movement path at 180°, the gimbal may be stopped when using the shortest path to move to the target attitude. When the follower gimbal (the gimbal at position 2) moves to the position of the mechanical position limit under the dual-gimbal linkage control, the follower gimbal may keep hitting the position of the mechanical position limit and cannot be adjusted to the determined attitude in time.

In some embodiments, the active gimbal may transmit the current joint angle data of the active gimbal to the follower gimbal to cause the joint angle data of the follower gimbal to be adjusted to be the same as the current joint angle data of the active gimbal to avoid the mechanical position limit of the follower gimbal during the process of adjusting the follower gimbal to the target attitude.

In some embodiments, when an absolute value of the difference between the current joint angle data of the active gimbal and the current joint angle data of the follower gimbal is greater than 180°, the follower gimbal may be adjusted to the attitude corresponding to the current joint angle data of the active gimbal according to the predetermined movement direction. The predetermined movement direction may be opposite to the direction, in which the follower gimbal moves to the attitude corresponding to the current joint angle data of the active gimbal in the shortest path. The direction in which the follower gimbal moves to an attitude in the shortest path is also referred to as a “shortest-path direction.”

The attitude of the yaw direction of the gimbal is taken as an example to describe the follower gimbal avoiding the mechanical position limit.

As shown in FIG. 5, the left pane is a schematic diagram showing a rotation of the yaw axis motor of the active gimbal. The right pane is a schematic diagram showing a rotation of the yaw axis motor of the follower gimbal. For example, a current joint angle of the yaw axis motor corresponding to the current yaw attitude of the active gimbal is 0°. A current joint angle of the yaw axis motor corresponding to the current yaw attitude of the follower gimbal is 350°. The direction, in which the follower gimbal moves to the attitude corresponding to the current joint angle data of the active gimbal in the shortest path, is 350°→351°→. . . →359°→360° (a direction indicated by a solid bold arrow on the right side of FIG. 5). If the joint angle of the active gimbal corresponding to the target attitude is 90°, a rotation path of the gimbal at position 1 is 0°→1°→. . . →89°→90° (a direction indicated by a solid arrow on the left side of FIG. 5). There are two paths for the gimbal at position 2 to rotate to the target attitude. A shortest path of the two paths is 360°→361°→. . . →450° (a direction indicated by a dashed bold arrow on the right side of FIG. 5). In the shortest path, the gimbal at position 2 will pass the position of the mechanical position limit, for example, 380°. The other path of the two paths is 360°→359°→. . . →90° (a direction indicated by a solid arrow on the right side of FIG. 5). The gimbal at position 2 may be stuck at the mechanical position limit in the shortest path. Thus, after the joint angle of the yaw axis motor of the follower gimbal is adjusted from 360° to 380°, the follower gimbal may be stuck or need to move to the target attitude by taking the other path. Therefore, the follower gimbal cannot be adjusted to the determined attitude in time, which causes negative user experience. The linkage control of the yaw attitude of the active gimbal and the follower gimbal is described as an example, which cannot be understood as a limitation of the present disclosure.

In some embodiments, the active gimbal may transmit the joint angle data of the active gimbal, i.e., 0°, to the follower gimbal. The follower gimbal may obtain the joint angle of the follower gimbal, that is, 350°. The absolute value of the difference between the current joint angle data of the active gimbal and the current joint angle data of the follower gimbal is greater than 180°. Thus, the follower gimbal may not rotate clockwise from 350° to 360° in the shortest path to face the same direction as the active gimbal. The follower gimbal may rotate counterclockwise in a direction opposite to that of the shortest path to 0°, such that the joint angle position of the follower gimbal is consistent with the joint angle position of the active gimbal. That is, the joint angle alignment is performed on the follower gimbal and the active gimbal. Then, after the target attitude is received, for example, as shown in FIG. 5, the active gimbal needs to rotate to a direction where the joint angle of 90° is, then the follower gimbal may rotate to 90° in dashed-line direction. During the process, the follower gimbal rotates to 0° in the solid-line direction and then to 90° in the dashed-line direction.

In some embodiments, the active gimbal transmits both the joint angle 0° of the active gimbal and the joint angle direction of the target attitude (90°) to the follower gimbal, the follower gimbal may first determine the rotation direction to be a counterclockwise direction (the direction indicated by the solid arrow on the right side of FIG. 5) according to the joint angle of 350° of the follower gimbal. Then, the follower gimbal may determine the target of the counterclockwise rotation is to the joint angle of 90°. During the process, the follower gimbal may rotate to 90° in the solid-line direction and may not need to rotate to 0° first.

In the former manner of the above two manners, the joint angle data and the target attitude of the active gimbal may be transmitted separately. Thus, the follower gimbal may perform the joint angle alignment first and then perform the attitude linkage. In the latter manner of the above two manners, the joint angle data and the target attitude of the active gimbal may be transmitted together. Thus, the follower gimbal may determine the rotation direction of the follower gimbal according to whether the difference between the joint angle of the active gimbal and the joint angle of the follower gimbal is greater than 180°. Then, the follower gimbal may directly rotate to the joint angle corresponding to the target attitude.

When the target attitude parameter is transmitted to the follower gimbal, if a dead zone exists, the target attitude parameter may be forwarded without considering the dead zone to cause the follower gimbal to be adjusted to the target attitude. The dead zone may be a minimum threshold value of an angle difference between the active gimbal and the follower gimbal required when a parameter is forwarded from the active gimbal to the follower gimbal.

When the UAV is hovering or in flight, because of vibration of a vehicle body, even if no external apparatus is controlling the movement of the gimbal, the measurement attitude of the gimbal may change in a certain range. However, if the follower gimbal (the gimbal at position 2) receives the measurement attitude that changes within the certain range as the target attitude, the follower gimbal may also shake. To suppress such shaking phenomena, dead zone protection may be added to the UAV. The dead zone protection may refer to that only when a measurement attitude difference of the two gimbals is equal to or greater than 1°, an angle control instruction may be transmitted to the follower gimbal. However, when the UAV flies violently, a situation may exist that although the movement of the gimbal is not controlled, the attitude difference is greater than 1°, which may cause the image to shake stronger. To solve this problem, in some embodiments, a limitation of the dead zone is removed, and the control accuracy is improved by transmitting the parameter corresponding to the target attitude not the measurement attitude of the active gimbal to the follower gimbal.

Further, obtaining the target attitude parameter of the target attitude of the active gimbal includes obtaining the target attitude parameter of the target attitude with a determined accuracy of the active gimbal. The determined accuracy may be higher than an attitude measurement accuracy of the active gimbal.

The gimbal may not have enough accuracy when rotating slowly. The gimbal may rotate slowly when the UAV flies slowly. When a communication capacity (bandwidth) allows, the higher the determined accuracy is, the higher the control accuracy is when the gimbal rotates slowly.

In some embodiments, the determined accuracy may include a data type of the target attitude parameter that may be float data type.

The method further includes transmitting a flag bit indicating the active gimbal is in a predetermined mode to the follower gimbal. When the active gimbal adjusts the attitude in the predetermined mode, the follower gimbal may be caused to move to a predetermined position.

In some embodiments, the predetermined position includes zero position of the joint angle of the follower gimbal.

In a linkage control mode, maybe only the active gimbal receives an alignment instruction, which may cause the follower gimbal to perform an unnecessary adjustment according to the target attitude of the gimbal at position 1. For example, only the gimbal at position 1 receives the alignment instruction. The gimbal at position 2 may still receive the target attitude of the gimbal at position 1 to follow the gimbal at position 1. In some embodiments, unnecessary linkage of the follower gimbal may be prevented to improve user experience.

In some embodiments, the predetermined mode includes a compass alignment mode and/or a gimbal automatic alignment mode.

If any attitude adjustment instruction that needs to be transmitted to the active gimbal but does not need to be transmitted to the follower gimbal exists, the solutions of embodiments of the present disclosure may be used. The examples of the compass alignment mode and the gimbal automatic alignment mode may not be understood as a limitation of embodiments of the present disclosure.

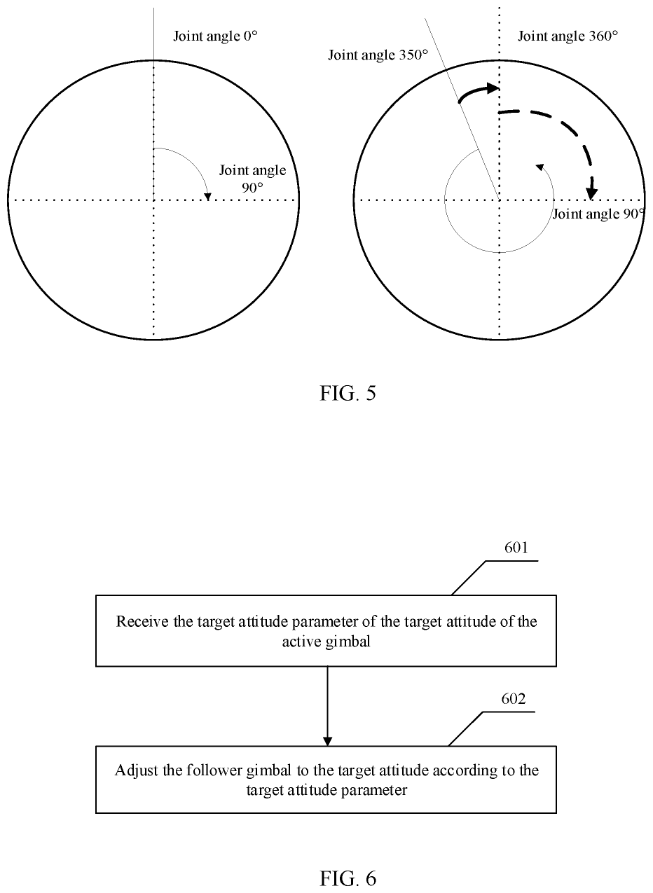

Embodiments of the present disclosure further provide another gimbal control method. The gimbals may include the active gimbal and the follower gimbal. The active gimbal and the follower gimbal may be in the linkage control mode, and the method can be executed by the follower gimbal. As shown in FIG. 6, the method includes receiving the target attitude parameter of the target attitude of the active gimbal (601) and adjusting the follower gimbal to the target attitude according to the target attitude parameter (602). The target attitude is the attitude where the active gimbal will move to.

For the parameter received by the follower gimbal and related control contents, reference can be made to the description of the active gimbal above, which is not repeated here.

The method further includes receiving the current joint angle data of the active gimbal and adjusting the joint angle data of the follower gimbal to be equal to the current joint angle data of the active gimbal to cause the follower gimbal to avoid the mechanical position limit of the follower gimbal when the follower gimbal is adjusted to the target attitude.

In some embodiments, adjusting the joint angle data of the follower gimbal to be equal to the current joint angle data of the active gimbal to cause the follower gimbal to avoid the mechanical position limit of the follower gimbal when the follower gimbal is adjusted to the target attitude includes when the absolute value of the difference between the current joint angle data of the active gimbal and the current joint angle data of the follower gimbal is greater than 180°, adjusting the follower gimbal to the attitude corresponding to the current joint angle data of the active gimbal according to the predetermined movement direction. The predetermined movement direction may be opposite to the direction, in which the follower gimbal moves to the attitude corresponding to the current joint angle data of the active gimbal in the shortest path.

In some embodiments, the current joint angle data of the active gimbal may include at least one of the joint angle of the yaw axis motor, the joint angle of the pitch axis motor, or the joint angle of the roll axis motor of the active gimbal.

The method further includes controlling the follower gimbal to exit a mode of the gimbal following the UAV.

In the linkage control mode, different gimbals may be in different control modes. For example, the gimbal at position 1 may be in a mode of the UAV following the gimbal (UAV-following-gimbal mode), and the gimbal at position 2 may be in the mode of the gimbal following the UAV (gimbal-following-UAV mode). Under such a situation, the gimbal at position 1 may rotate first, then the UAV may follow the gimbal at position 1. Then, the gimbal at position 2 may superimpose the instruction of following the gimbal at position 1 on the instruction of following the UAV, which may cause the gimbal at position 2 to be unable to keep up and overshoot at an arrival position. In addition, when the gimbal at position 2 receives the instruction of following the gimbal at position 1, the instruction of following the gimbal at position 1 may be superimposed on the current instruction. If the gimbal at position 2 does not exit the mode of the gimbal following the UAV actively, the gimbal control may be unstable. To solve the technical problem, in the dual-gimbal linkage control mode of embodiments of the present disclosure, the follower gimbal may be controlled to exit the mode of the gimbal following the UAV.

In some embodiments, receiving the target attitude parameter of the target attitude of the active gimbal includes receiving the target attitude parameter of the target attitude with the predetermined accuracy of the active gimbal. The predetermined accuracy may be higher than the attitude measurement accuracy of the active gimbal.

In some embodiments, the data type of the target attitude parameter may include the float data type.

In some embodiments, the method further includes receiving the flag bit indicating the active gimbal is in the predetermined mode and when determining that the active gimbal adjusts the attitude in the predetermined mode according to the flag bit, moving the follower gimbal to the predetermined position.

In some embodiments, the predetermined position may include the zero position of the joint angle of the follower gimbal.

In some embodiments, the predetermined mode may include the compass alignment mode and/or the gimbal automatic alignment mode.

Based on the description of embodiments of the present disclosure above, embodiments of the present disclosure further provide two gimbals, which may be used as the active gimbal and the follower gimbal, respectively. The description of above method embodiments can be referred to for the following device embodiments about the gimbals.

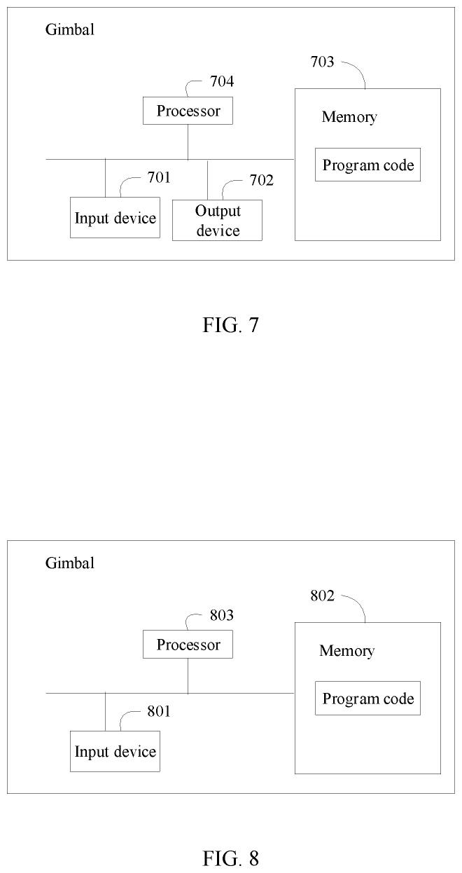

Embodiments of the present disclosure further provide a gimbal, which may be applied to a UAV. The UAV may include an active gimbal and a follower gimbal. The gimbal may be used as the active gimbal. As shown in FIG. 7, the gimbal includes an input device 701, an output device 702, a memory 703, and a processor 704.

The memory 703 may store program code.

The processor 704 may be configured to call the program code. The program code, when being executed, causes the processor 704 to control the input device 701 to obtain the target attitude parameter of the target attitude of the active gimbal and control the output device 702 to transmit the target attitude parameter to the follower gimbal to cause the follower gimbal to be adjusted to the target attitude. The target attitude may be the attitude where the active gimbal will move to.

In some embodiments, after the target attitude parameter of the target attitude of the active gimbal is obtained, the target attitude parameter may be transmitted to the follower gimbal. Thus, the follower gimbal may perform adjustment according to the target attitude of the active gimbal but not using the current attitude of the active gimbal as the target. Thus, the follower gimbal may synchronize with the active gimbal more quickly, and the attitude difference between the follower gimbal and the active gimbal may be reduced.

Further, the processor 704 may be further configured to control the output device 702 to transmit the current joint angle data of the active gimbal to the follower gimbal to cause the joint angle data of the follower gimbal to be adjusted to be equal to the current joint angle data of the active gimbal to cause the follower gimbal to avoid the mechanical position limit of the follower gimbal during the process of adjusting the follower gimbal to the target attitude.

In some embodiments, causing the joint angle data of the follower gimbal to be adjusted to be equal to the current joint angle data of the active gimbal to cause the follower gimbal to avoid the mechanical position limit of the follower gimbal during the process of adjusting the follower gimbal to the target attitude includes when the absolute value of the difference between the current joint angle data of the active gimbal and the current joint angle data of the follower gimbal is greater than 180°, adjusting the follower gimbal to the attitude corresponding to the current joint angle data of the active gimbal according to the predetermined movement direction. The predetermined movement direction may be opposite to the direction, in which the follower gimbal moves to the attitude corresponding to the current joint angle data of the active gimbal in the shortest path.

In some embodiments, the current joint angle data of the active gimbal may include at least one of the joint angle of the yaw axis motor, the joint angle of the pitch axis motor, or the joint angle of the roll axis motor of the active gimbal.

In some embodiments, the processor 704 may be further configured to control the active gimbal to exit the mode of the gimbal following the UAV.

In some embodiments, the processor 704 controlling the input device 701 to obtain the target attitude parameter of the target attitude of the active gimbal includes controlling the input device 701 to obtain the target attitude parameter of the target attitude with the predetermined accuracy of the active gimbal. The predetermined accuracy may be higher than the attitude measurement accuracy of the active gimbal.

In some embodiments, the data type of the target attitude parameter may include the float data type.

In some embodiments, the processor 704 may be further configured to control the output device 702 to transmit the flag bit indicating the active gimbal is in the predetermined mode to the follower gimbal and when the active gimbal adjusts the attitude in the predetermined mode, causing the follower gimbal to move to the predetermined position.

In some embodiments, the predetermined position may include the zero position of the joint angle of the follower gimbal.

In some embodiments, the predetermined mode may include the compass alignment mode and/or the gimbal automatic alignment mode.

Embodiments of the present disclosure further provide another gimbal, which may be applied by the UAV. The UAV may include the active gimbal and the follower gimbal. The gimbal may be used as the follower gimbal. As shown in FIG. 8, the gimbal includes an input device 801, the memory 802, and the processor 803.

The memory 802 may store a program code.

The processor 803 may be configured to call the program code that, when executed, causes the processor 803 to control the input device 801 to receive the target attitude parameter of the target attitude of the active gimbal and control the follower gimbal to be adjusted to the target attitude according to the target attitude parameter. The target attitude may be the attitude where the active gimbal will move to.

In some embodiments, the processor 803 may be further configured to control the input device to receive the current joint angle data of the active gimbal.

The processor 803 may be further configured to control the joint angle data of the follower gimbal to be adjusted to be equal to the current joint angle data of the active gimbal to cause the follower gimbal to avoid the mechanical position limit during the process of adjusting the follower gimbal to the target attitude.

In some embodiments, the processor 803 controlling the joint angle data of the follower gimbal to be adjusted to be equal to the current joint angle data of the active gimbal to cause the follower gimbal to avoid the mechanical position limit during the process of adjusting the follower gimbal to the target attitude includes when the absolute value of the difference between the current joint angle data of the active gimbal and the current joint angle data of the follower gimbal is greater than 180°, adjusting the follower gimbal to the attitude corresponding to the current joint angle data of the active gimbal according to the predetermined movement direction. The predetermined movement direction may be opposite to the direction, in which the follower gimbal moves to the attitude corresponding to the current joint angle data of the active gimbal in the shortest path.

In some embodiments, the current joint angle data of the active gimbal may include at least one of the joint angle of the yaw axis motor, the joint angle of the pitch axis motor, or the joint angle of the roll axis motor of the active gimbal.

In some embodiments, the processor 803 may be further configured to control the follower gimbal to exit the mode of the gimbal following the UAV.

In some embodiments, the processor 803 controlling the input device 801 to obtain the target attitude parameter of the target attitude of the active gimbal includes controlling the input device 801 to obtain the target attitude parameter of the target attitude with the predetermined accuracy of the active gimbal. The predetermined accuracy may be higher than the attitude measurement accuracy of the active gimbal.

In some embodiments, the data type of the target attitude parameter may include the float data type.

In some embodiments, the processor 803 may be further configured to control the input device 801 to receive the flag bit indicating the active gimbal is in the predetermined mode and when the active gimbal adjusts the attitude in the predetermined mode, causing the follower gimbal to move to the predetermined position.

In some embodiments, the predetermined position may include the zero position of the joint angle of the follower gimbal.

In some embodiments, the predetermined mode may include the compass alignment mode and/or the gimbal automatic alignment mode.

Embodiments of the present disclosure further provide a UAV. The UAV may include a vehicle body, a power system, and a load. The power system may be mounted at the vehicle body and configured to provide power to the mobile platform. The load may be mounted at the vehicle body. As shown in FIG. 2, the load includes the active gimbal and the follower gimbal. The active gimbal may include any gimbal of embodiments of the present disclosure, which is used as the active gimbal. The follower gimbal may include any gimbal of embodiments of the present disclosure, which is used as the follower gimbal.

Embodiments of the present disclosure further provide a readable storage medium. The readable storage medium stores the program code of method embodiments of the present disclosure.

Those of ordinary skill in the art may understand that all or part of the steps in the various methods of embodiments of the present disclosure may be completed by a program instructing relevant hardware. The program may be stored in a computer-readable storage medium, and the storage medium may include a flash drive, a read-only memory (ROM), a random access memory (RAM), magnetic disks, etc.

Although the present disclosure is described with reference to various embodiments, in the process of implementing the claimed present invention, those skilled in the art may understand and realize and implement another variation of embodiments of the present invention by viewing the accompanying drawings, disclosure, and appended claims. In the claims, the word “comprising” does not exclude other components or steps, and “a” or “one” does not exclude a plurality. A single processor or another unit may implement several functions listed in the claims. Certain measures are described in mutually different dependent claims, which does not mean that these measures cannot be combined to generate a good effect.

What is claimed is:

1. A gimbal control method comprising:
obtaining a target attitude parameter of a target attitude of an active gimbal, the target attitude being an attitude that the active gimbal is moving to; and
transmitting the target attitude parameter to a follower gimbal to adjust the follower gimbal to the target attitude.

2. The method of claim 1, further comprising:
transmitting current joint angle data of the active gimbal to the follower gimbal to adjust a joint angle of the follower gimbal to be same as a current joint angle of the active gimbal to avoid a mechanical position limit of the follower gimbal during a process of adjusting the follower gimbal to the target attitude.

3. The method of claim 2, wherein in response to an absolute value of a difference between the current joint angle of the active gimbal and a current joint angle of the follower gimbal being greater than 180°, the follower gimbal is adjusted to an attitude corresponding to the current joint angle data of the active gimbal according to a predetermined movement direction, the predetermined movement direction being opposite to a direction, in which the follower gimbal moves to the attitude corresponding to the current joint angle data of the active gimbal in a shortest path.

4. The method of claim 2, wherein the current joint angle data of the active gimbal includes at least one of a joint angle of a yaw axis motor of the active gimbal, a joint angle of a pitch axis motor of the active gimbal, or a joint angle of a roll axis motor of the active gimbal.

5. The method of claim 1, wherein obtaining the target attitude parameter of the target attitude of the active gimbal includes:
obtaining the target attitude parameter of the target attitude with a predetermined accuracy of the active gimbal, the predetermined accuracy being higher than an attitude measurement accuracy of the active gimbal.

6. The method of claim 1, wherein a data type of the target attitude parameter includes a float data type.

7. The method of claim 1, further comprising:
transmitting, to the follower gimbal, a flag bit indicating the active gimbal is in a predetermined mode to cause the follower gimbal to move to a predetermined position when the active gimbal is adjusting an attitude in the predetermined mode.

8. The method of claim 7, wherein the predetermined position includes a zero joint angle of the follower gimbal.

9. The method of claim 7, wherein the predetermined mode includes at least one of a compass alignment mode or a gimbal automatic alignment mode.

10. A gimbal configured as an active gimbal of an unmanned aerial vehicle comprising:
an input device;
an output device;
a processor; and
a memory storing a program code that, when executed, causes the processor to:
control the input device to obtain a target attitude parameter of a target attitude of the active gimbal, the target attitude being an attitude that the active gimbal is moving to; and
control the output device to transmit the target attitude parameter to a follower gimbal included in the unmanned aerial vehicle to adjust the follower gimbal to the target attitude.

11. The gimbal of claim 10, wherein the program code further causes the processor to:
control the output device to transmit current joint angle data of the active gimbal to the follower gimbal to adjust joint angle of the follower gimbal to be same as a current joint angle of the active gimbal to avoid a mechanical position limit of the follower gimbal during a process of adjusting the follower gimbal to the target attitude.

12. The gimbal of claim 11, wherein the program code further causes the processor to:
in response to an absolute value of a difference between the current joint angle of the active gimbal and a current joint angle of the follower gimbal being greater than 180°, adjust the follower gimbal to an attitude corresponding to the current joint angle data of the active gimbal according to a predetermined movement direction, the predetermined movement direction being opposite to a direction, in which the follower gimbal moves to the attitude corresponding to the current joint angle data of the active gimbal in a shortest path.

13. The gimbal of claim 11, wherein the current joint angle data of the active gimbal includes at least one of a joint angle of a yaw axis motor of the active gimbal, a joint angle of a pitch axis motor of the active gimbal, or a joint angle of a roll axis motor of the active gimbal.

14. The gimbal of claim 10, wherein the program code further causes the processor to:
obtain the target attitude parameter of the target attitude with a predetermined accuracy of the active gimbal, the predetermined accuracy being higher than an attitude measurement accuracy of the active gimbal.

15. The gimbal of claim 10, wherein a data type of the target attitude parameter includes a float data type.

16. The gimbal of claim 10, wherein the program code further causes the processor to:
Transmit, to the follower gimbal, a flag bit indicating the active gimbal is in a predetermined mode to cause the follower gimbal to move to a predetermined position when the active gimbal is adjusting an attitude in the predetermined mode.

17. The gimbal of claim 16, wherein the predetermined position includes a zero joint angle of the follower gimbal.

18. The gimbal of claim 16, wherein the predetermined mode includes at least one of a compass alignment mode or a gimbal automatic alignment mode.

19. An unmanned aerial vehicle comprising:
a vehicle body;
a power system mounted at the vehicle body and configured to provide power for the unmanned aerial vehicle;
an active gimbal including:
a first input device;
an output device;
a first processor; and
a first memory storing a first program code that, when executed, causes the first processor to:
control the input device to obtain a target attitude parameter of a target attitude of the active gimbal, the target attitude being an attitude that the active gimbal is moving to; and
control the output device to transmit the target attitude parameter to a follower gimbal to adjust the follower gimbal to the target attitude; and
a follower gimbal including:
a second input device;
a second processor; and
a second memory storing a second program code that, when executed, causes the second processor to:
control the second input device to receive the target attitude parameter of the target attitude of the active gimbal; and
control the follower gimbal to be adjusted to the target attitude according to the target attitude parameter.
